(19) United States
(12) Patent Application Publication
(10) Pub. No.: US 2021/0197967 A1
(43) Pub. Date: Jul. 1, 2021

(54) UAS DETECTION AND NEGATION

(71) Applicant: Embry-Riddle Aeronautical Univesrity, Inc., Daytona Beach, FL (US)

(72) Inventors: Houbing Song, Jacksonville, FL (US); Yongxin Liu, Daytona Beach, FL (US); Jian Wang, Daytona Beach, FL (US)

(21) Appl. No.: 16/843,777

(22) Filed: Apr. 8, 2020

Related U.S. Application Data
(60) Provisional application No. 62/833,153, filed on Apr. 12, 2019.

(51) Int. Cl. B64C 39/02; G08G 5/00; H04K 3/00

(52) U.S. Cl. CPC B64C 39/024; G08G 5/0013; H04B 1/0003; H04K 3/43; G08G 5/006

(57) ABSTRACT

Unauthorized operation of a UAV may present privacy or security risks. A software-defined radio (SDR) or other receiver can be used to monitor a specified range of frequencies to provide detection of wireless communication signals suspected of relating to UAV operation. A protocol detector corresponding to a trained classifier can be applied to data packets demodulated by the SDR. A transmitter can then be triggered to provide warnings by injecting warning data into a video channel in response to the detected protocol. Control of the UAV can be established by transmitting simulated control commands that overwhelm the signals received from the UAVs normal remote control. If transmission of warnings or simulated control signals fail to suppress unwanted UAV operation, other actions can be triggered such as jamming or dispatch of an interceptor such as a surveillance UAV.

### CLAIM OF PRIORITY

This patent application claims the benefit of priority of Song et al., U.S. Provisional Patent Application Ser. No. 62/833,153, titled “UAS DETECTION AND NEGATION,” filed on Apr. 12, 2019 (Attorney Docket No. 4568.006PRV), which is hereby incorporated by reference herein in its entirety.

### FIELD OF THE DISCLOSURE

This document pertains generally, but not by way of limitation, to unmanned aerial systems (UASs), such as including an unmanned aerial vehicle (UAV) and a corresponding ground control station, and more particularly, to detection of UAVs, and optionally, negation of such vehicles.

### BACKGROUND

The advent of new technologies has led to the emergence of relatively inexpensive, highly-maneuverable unmanned aerial vehicles (UAVs). Such UAVs have raised concerns regarding privacy, public safety, and security. One threat posed by unauthorized operation of a UAV is inadequate control over UAVs that penetrate sensitive areas. In one approach, an acoustic (e.g., sound-based) technique can be used to identify a presence of a UAV. However, such an approach can present challenges. For example, an acoustic technique may only provide limited detection range and may not be able to provide spatial localization of a detected UAV location, particularly in three dimensions. In another approach, UAVs could be required to transmit their position using a standardized protocol or beacon, such as using Automated Dependent Surveillance-Broadcast (ADS-B). However, such an approach can also present challenges. Many existing UAVs are not equipped (and may not be economically equipped) to provide beaconing, particularly “ADS-B Out” transmission capability, or such a transmitter could be intentionally disabled by the user to more easily penetrate sensitive areas without detection.

### SUMMARY OF THE DISCLOSURE

Radio-controlled unmanned aerial vehicles (UAVS) provide a way to perform certain difficult tasks without the need of putting a human pilot at risk. UAVs have long been used to perform military tasks and surveillance tasks; however, in recent years the availability of low-cost components has reduced the unit cost of producing UAVs. Accordingly, UAVs are now more accessible to other industries and even to individual hobbyists. However, the arbitrary use of UAVs by hobbyists and amateurs has raised concerns in terms of privacy and public security. For example, unauthorized UAVs with cameras can easily become intruders when flying over sensitive areas such as nuclear plants or high-value targets, or when flying into certain areas of airports.

The present inventors have recognized, among other things, that hobbyist and amateur UAVs, in particular, are typically small and difficult to detect by traditional radars, and that other approaches can help alleviate threats from any type of UAV. In some approaches, a wireless distributed acoustic sensor network can identify the appearance and estimate the position of trespassing UAVs that have entered or are about to enter a sensitive area. Once such a UAV is detected, to cope with the diversity in RF characteristics and telemetry protocols of amateur UAVs, the subject matter described herein can include a software defined radio (S DR) platform to capture and use machine learning approaches to identify and decode the telemetry protocols of the suspected trespassing UAV. Finally, when the UAV is confirmed to be unauthorized, control commands can be utilized to route that UAV away from sensitive areas.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a surveillance system for detecting and responding to amateur UAVs.

FIG. 2 illustrates signaling between various components of a system in which example embodiments can be implemented.

FIG. 3 illustrates a general workflow of a UAV detection negation technique.

FIG. 4 illustrates a scheme for generating training data.

FIG. 5A illustrates a workflow of radio channel identification and reaction.

FIG. 5B illustrates modulation identification and data recovery.

FIG. 5C illustrates workflow of protocol identification.

FIG. 6 illustrates a block diagram of an example comprising a machine upon which any one or more of the techniques (e.g., methodologies) discussed herein may be performed.

### DETAILED DESCRIPTION

As mentioned above, the use of UAVs by hobbyists and amateurs has raised concerns in terms of privacy and public security. For example, unauthorized UAVs with cameras can easily be considered intruders when flying over sensitive areas such as nuclear plants or other high-value targets (e.g., government or military installations, sports arenas). According to the United States Federal Aviation Administration (FAA), more than 500 such unauthorized UAV operations were spotted between July and September 2016. UAVs can be used as weapons if they are made to carry explosive payloads or are otherwise under the control of terrorists. Despite such concerns, unauthorized amateur UAV operations remain difficult to detect or control, due in part to the fact that small-size UAVs are difficult to detect by traditional radars (e.g., aviation surveillance radar) and generally lack a radio beacon. Generally, UAVs are not entirely autonomous and a ground control station (e.g., a handheld remote control or other device) is used to control the UAV. Even if a location of UAV is determined, challenges may still exist in determining a location of a corresponding remote control on the ground.

The present inventors have recognized, among other things, that at least some of the challenges mentioned above can be addressed through apparatus and techniques as shown and described herein. Such apparatus and techniques can include one or more of detection and negation or “eviction” of an unauthorized UAV from a sensitive area. First, systems described herein can include a wireless distributed acoustic sensor network to identify the appearance and estimate the position of unwelcome UAVs. Furthermore, a software-defined radio (SDR) can use machine learning approaches to identify ad decode the telemetry protocols of the unauthorized UAV. Negation can be achieved such as by injecting a negation command, such as control commands, into a control channel once the telemetry protocol has been recognized. Negation can also include transmission of a warning or other notification by injecting a video signal or image data according to the detected protocol, to appear on a display of the remote control. Such transmission can also be accomplished using an SDR-based transmitter.

If the techniques fail to properly classify the protocol, jamming can be used to block communication between the ground control station and the UAV. A transmit power used for one or more of commandeering control, injecting warning information, or blocking of communication can include modulation of transmit power. Such modulation can include establishing a transmit power sufficient to achieve the desired control, warning injection, or signal blocking, without precluding operation of UAVs nearby or otherwise causing unwanted interference. Generally, the approaches described herein can proactively secure a protected physical area from unauthorized UAV operation while still otherwise permitting normal UAV operation elsewhere. Approaches described herein can use information from different sources to include detection accuracy, and distributed sensing can increase range of coverage and sensitivity.

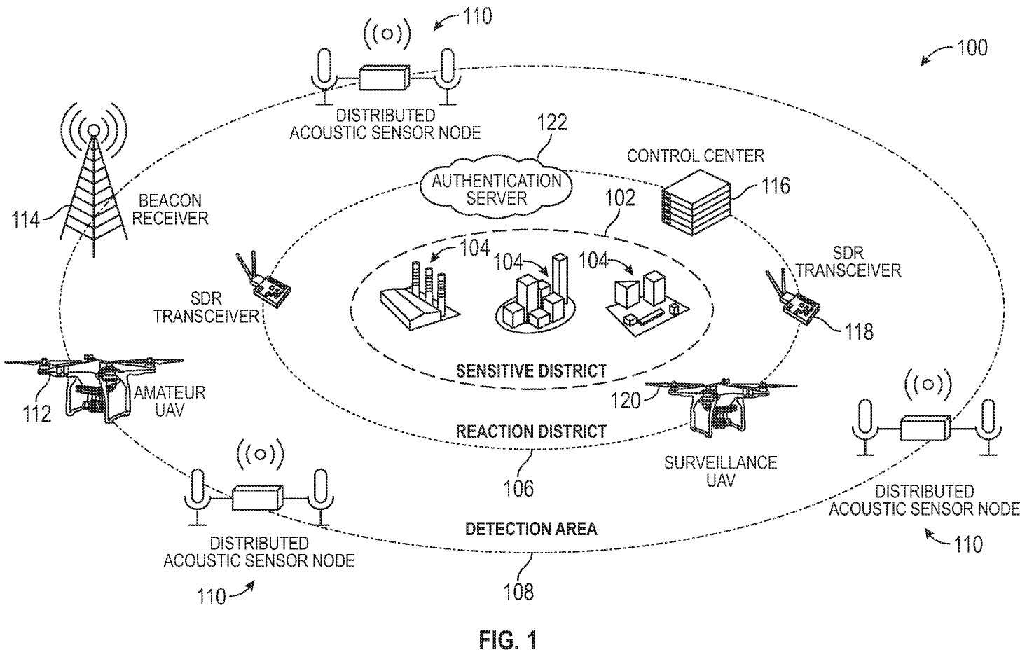

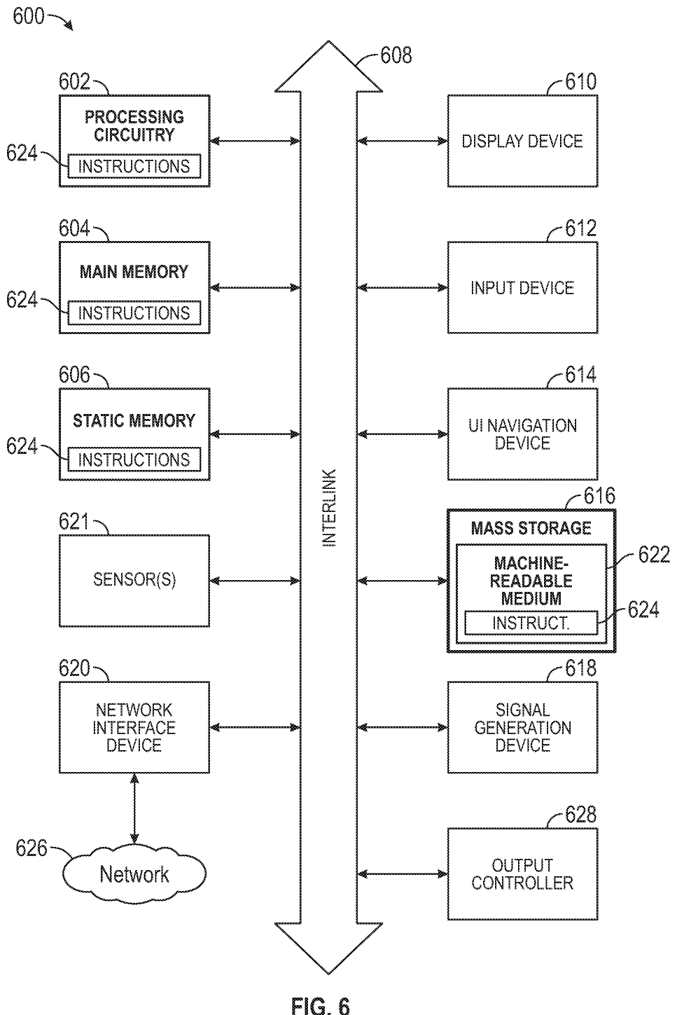

FIG. 1 illustrates a surveillance system 100 for detecting and responding to amateur UAVs. A sensitive area 102 can be defined within a radius of governmental or industrial buildings 104 or other facilities or sites that can include sensitive information or resources. A reaction district 106 can be defined outside the sensitive area 102, and a detection area 108 can be defined outside the reaction district 106. The distributed. wireless acoustic sensors 110 (within the detection area 108 but outside the reaction area. 106) can detect pervasive acoustic signals to determine presence of an object 112. The object 112 (e.g., unwelcome UAV) can attempt to cruise into detection area 108, and potentially into reaction area 106 or sensitive area 102, without legible RF beacons or other signals for identity verification. If more than one sensor 110 detects the object 112, then a location for the object 112 can be estimated. Additionally, beacon receivers 114 (within the detection area 108 but outside the reaction area 106) can detect identity verification signals (e.g., ADS-B) from a radio channel. Beacon receivers 114 can include, for example, base stations operating in accordance with cellular standards, or any other system capable of transmitting and receiving RF signals. Results of location information, acoustic information, and identity verification signals can be provided (e.g., transmitted by the beacon receiver 114) to a control center 116. The control center 116 (or, e.g., processing circuitry 602 (FIG. 6) or other computer system within the control center 116) can trigger various actions described below if the control center 116 determines that the object 112 is a trespassing UAV, according to criteria described later herein, or if the control center 116 cannot identify the object 112 based on information provided by sensors 110 or beacon receiver 114.

SDR receivers 118 scan radio channels typically used by amateur UAVs (e.g., object 112 or similar UAVs) of a detection area 108 or areas within a threshold distance of the detection area 108. By using pattern recognition techniques described later herein, processing circuitry (e.g., processing circuitry 602 (FIG. 6) included in, for example, SDR receivers 118, surveillance UAVs 120, control center 116, or authentication server 122), the telemetry control and video streaming channel of the object 112 can be identified.

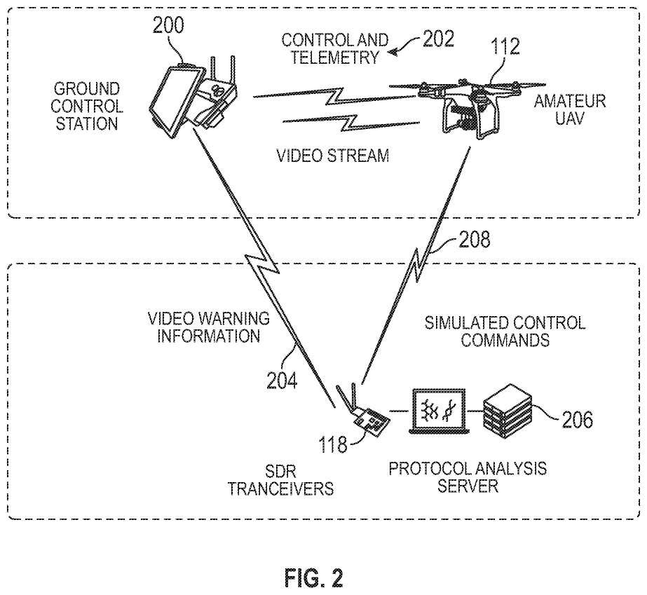

FIG. 2 illustrates signaling between various components of a system in which example embodiments can be implemented. Some amateur UAVs (e.g., object 112), maintain at least two data links with a ground station 200: a bidirectional telemetry link 202 to receive commands and a unidirectional analog video stream channel 204. By using pattern recognition techniques described later herein, processing circuitry (e.g., processing circuitry 602 (FIG. 6) included in, for example, SDR receivers 118, surveillance UAVs 120, control center 116, authentication server 122, or protocol analysis server 206), the telemetry control and video streaming channel of the object 112 can be identified. Upon such identification, apparatuses and systems according to embodiments can transmit warning information into the analog video stream channel 204 to attempt to direct the operator of the object 112 to evacuate the surveillance area. In other embodiments, telemetry link 202 can be jammed or blocked, which can cause the object 112 to return to ground station 200.

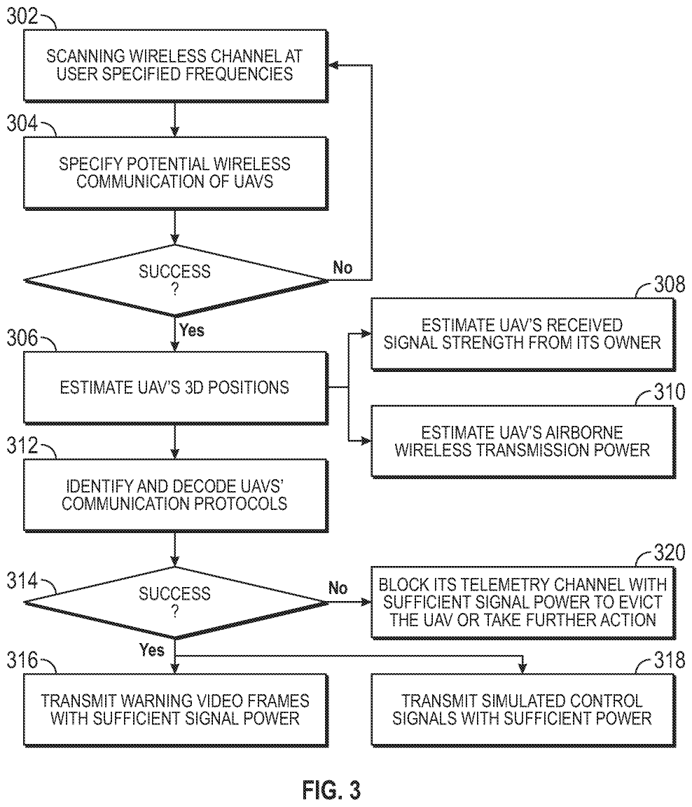

FIG. 3 illustrates a general workflow of a UAV detection and negation technique 300. Operations of technique 300 can be performed by processing circuitry (e.g., processing circuitry 602 (FIG. 6) included in, for example, SDR receivers 118, surveillance UAVs 120, control center 116, authentication server 122, or protocol analysis server 206). Technique 300 can begin with operation 302 by processing circuitry scanning a wireless channel for potential wireless communication signals (e.g., suspicious signals) corresponding to object 112 operation. Such scanning can include monitoring known ranges of frequencies corresponding to UAV telemetry or video transmission signals. As described with reference to FIG. 2 above, amateur UAVs generally maintain two radio links with the ground control station 200: a bidirectional telemetry link 202 to handle control commands and status information; and a unidirectional video stream (e.g., an analog video signal). If any signal is classified as being transmitted by a flying UAV or a UAV remote control (as processing circuitry determines in operation 304) the positions of one or more RF transmitters can be estimated in three dimensions (3D) in operation 306. Otherwise, scanning resumes in operation 302.

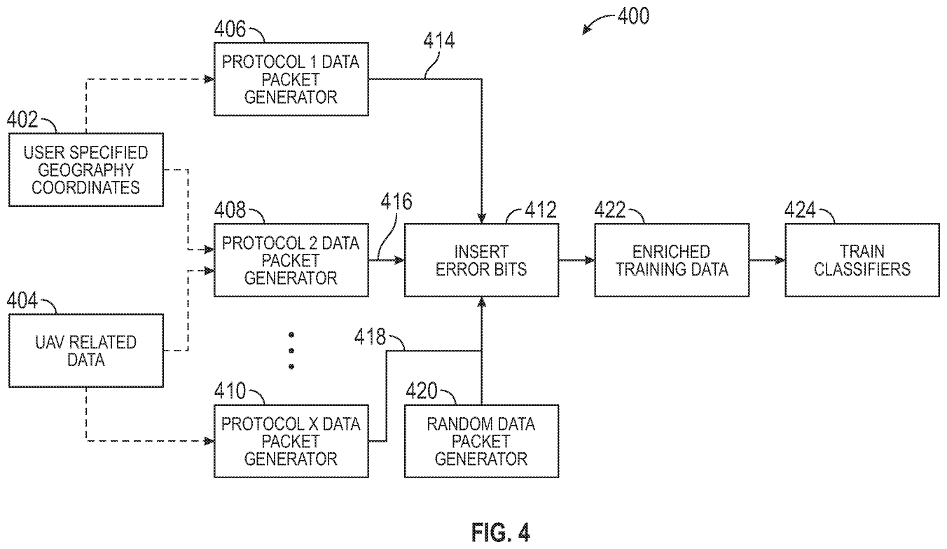

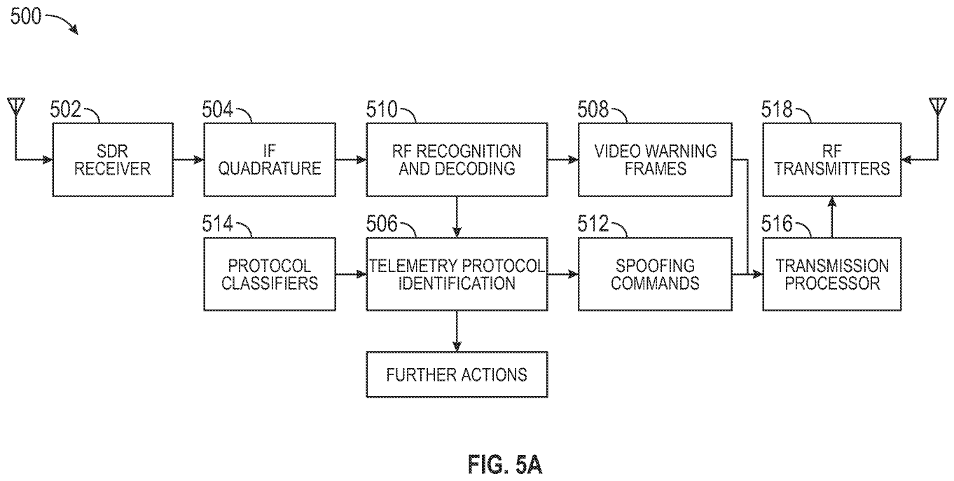

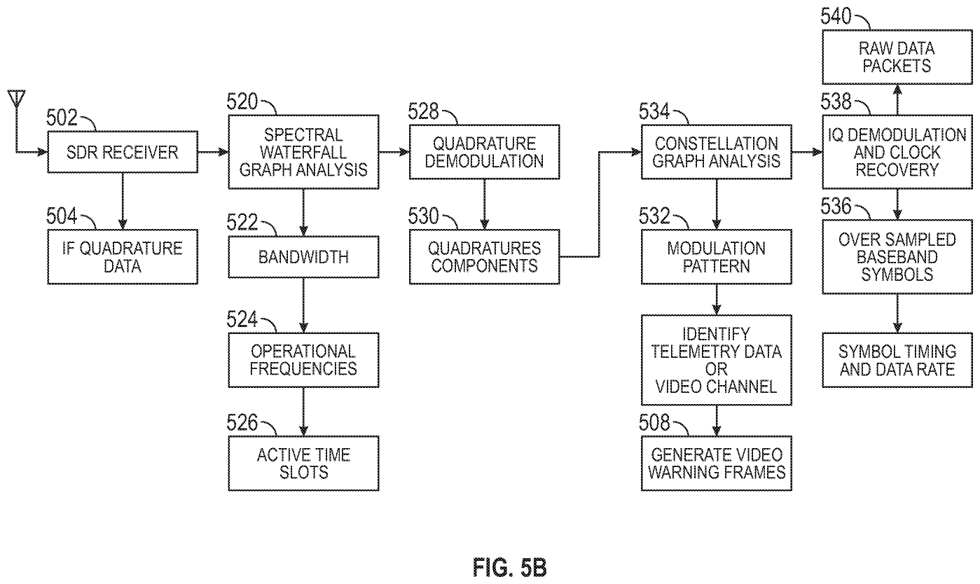

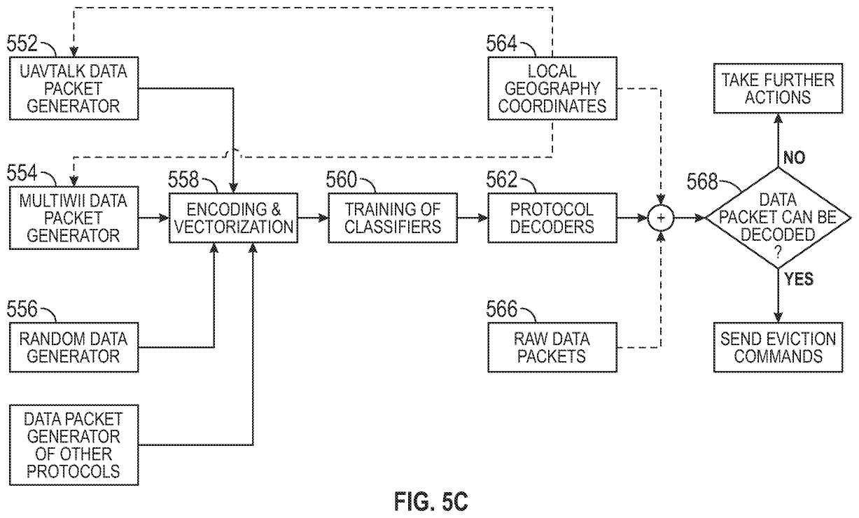

In operations 308 and 310, the processing circuitry estimates a signal power of at least one of a) a telemetry signal that is transmitted by object 112 airborne RF transmitter car b) a remaining signal strength available for use by the object 112 remote control. Depending on the signal power, the processing circuitry can use information regarding the signal power to help determine transmission power for negation transmissions, such as jamming, spoofing, warning, etc. In operation 312, the processing circuitry may decode a sample of the object 112 communication signals and use machine-learning-based classifiers to identify one or more of a video or a telemetry channel. Further details regarding operation 312 are provided below with reference to FIG. 4 and FIGS. 5A, 5B and 5C. If decoded geographic coordinates extracted from object 112 telemetry data is within a specified range of an expected object 112 location, the processing circuitry classifies the decoding as successful in operation 314. If a synchronization signal corresponding to a video frame is extracted, for example, the processing circuitry can consider the video streaming protocol to be identified successfully.

In operation 316, if the processing circuitry has detected a video streaming protocol, the processing circuitry may transmit, or encode for transmitting, one or more warning video frames using an identified protocol with sufficient power to overcome the normal video signal (e.g., a multiple of the object 112 video channel transmit power such as twice the normal video channel transmit power). In operation 318, if the processing circuitry identifies a telemetry protocol including control capability, the processing circuitry can transmit, or causes to be transmitted, simulated control commands (commands 212 (FIG. 2)) to commandeer the control of the object 112, such as to direct the object 112 out of a sensitive area. Transmission can be performed using sufficient power to overcome the normal control signal from the remote control (e.g., a multiple of the remote control transmit power such as twice the normal remote control transmit power). In this context, transmitting “simulated” control commands can refer to emulating the remote control in a manner to commandeer the control of the object 112.

In operation 320, if the processing circuitry has not identified video or telemetry protocols can be identified or otherwise classified to allow the video or telemetry to be commandeered, then jamming can be performed, such as to trigger a UAV program that causes the UAV to return or search autonomously to re-establish a link with the remote control. As in example 4a and 4b, such jamming can be performed using a transmitted power sufficient to block reception of control commands via the normal telemetry channel, but without necessarily disrupting operation of other UAVs farther away. Other actions can be triggered if video warnings are not heeded and control cannot be established. For examples, the detection techniques shown an described herein can be used to trigger dispatch of an interceptor, such as a surveillance UAV 120 (FIG. 1), to inspect or disable the intruding object 112.

Acoustic identification techniques, for example techniques executed by distributed wireless acoustic sensors 110 can be based on the inventors' observation that the spectrum of UAV acoustic signals differs from the sound of natural backgrounds. Specifically, a UAV acoustic spectrum has a stronger and more concentrated power spectrum and steeper cutoff frequency than that of natural background sounds. The observation also provides an indication that a low pass filter (LPF) with a cutoff frequency of, for example, 15 kHz, can eliminate unnecessary noise while preserving most acoustic information.

In some embodiments, instead of defining rules for acoustic identification, a support vector machine (SVM) is used. For each digitalized acoustic signal, fast Fourier transform (FFT) is used to convert time domain signals into a spectral series (including amplitude information only). To avoid manually defining rules for acoustic identification, the support vector machine (SVM) is employed. For each piece of digitalized acoustic signal Sᵢ={a₀, a₁ . . . aₙ} with length n, and class label I the fast Fourier transform (FFT) is used to convert time domain signals into the spectral series (amplitude only) Fi={w₀, w₁, . . . , wₙ}. Training sets are then generated and the wireless acoustic sensors 110 in the surveillance area (e.g., within the detection area 108 (FIG. 1) or within a threshold range outside 108 (FIG. 1)) perceive acoustic signals and use pretrained dimensional reduction matrices and classifiers to finish the pattern recognition of acoustic signals.

The wireless acoustic sensors 110 can use acoustic locating, based on the known speed of sound, to detect object 112 location (e.g., 3D location) such as may be performed in operation 306 (FIG. 3). The minimum distance between two neighboring microphones of a sensor 110 should be less than the shortest wavelength of the object 112 acoustic signal. In some examples, a sensor 110 can include more than two microphones, for example seven or more synchronized microphones. Data from multiple of the microphones of the sensor 110 is integrated with a time difference of arrival (TDOA) algorithm to detect the source of the acoustic signal (i.e., the position of the object 112 generating the acoustic signal). The sensors 110 can provide position information and other information to control center 116 or other central processing system. A synchronizing system (not shown in FIG. 1) may connect the sensors 110 and control center 116.

As mentioned above with respect to operation 312 (FIG. 3), a received sample of wireless communication can be automatically classified as either a telemetry or video signal relating to UAV operation, using a machine-learning-based classifier. Various training approaches can be used to enhance the performance of the classifier. For example, information used to train the classifier can be enriched by using a combination of a protocol generator along with captured “real-world” signals representative of UAV operation (including unregistered/private protocols). Protocol generators can generate data packets conforming to one or more UAV communication protocols (e.g., Micro Air Vehicle Link (MAVLink), UAVtalk” or MultiWii as illustrative examples).

A training approach can include generation of an enriched training dataset using a scheme 400 as shown generally in FIG. 4. The scheme 400 can be implemented by processing circuitry (e.g., processing circuitry 602 (FIG. 6) of control center 116 (FIG. 1)). The training data set generated according to scheme 400 can be used in a machine-learning-based classifier, the classifier established to perform classification of data corresponding to intercepted wireless signals suspected of relating to UAV operation.

Inputs can include user-specified geography coordinates 402, UAV-related data 404 (including, for example, make, model, size, manufacturer, etc.) The protocol generators 406, 408 and 410 can respectively randomly output different types of data packets (e.g., a flying status report, one or more control commands) having payloads established in at least a semi-randomized manner. In such a semi-randomized scheme, a range of different random values can be constrained such as to provide data within the bounds that would be reasonable in actual operation (for example, geographic coordinates or battery status values can be constrained to avoid nonsensical values). Noise in the channel can be simulated at 412 by randomly toggling bit values in the generated packets according to specified error criteria such as bit error rates, minimum or maximum run length of error sequences, or the like.

Packets 414, 416, 418 generated using known target protocols can be combined by packets 420 corresponding to random data, and respective packets can be labeled to provide an enriched corpus 422 of training data. Machine learning techniques 424 such as implemented as a random forest, a support vector machine (SVM, e.g., a one-against-all SVM) or a convolutional neural network (CNN) can then be established using the training data.

As mentioned above with respect to operations 316, 318 and 320 (FIG. 3), after a protocol is identified corresponding to a telemetry or video channel of an unauthorized UAV (e.g., object 112 (FIG. 1) in operation, various responses can be triggered. Such responses can include one or more of: (1) collaborative awareness, where warning information is transmitted to enable a UAV operator to proactive control their UAV to guide the UAV out of a sensitive area; or (2) transmission of control commands using adaptively-determined transmit power, where simulated commands are transmitted with sufficient power to achieve reliable control of the UAV bypassing the UAV operator remote control, but where the simulated commands are transmitted at a power level constrained to avoid interference with other communications (e.g., out-of-band or in-band corresponding to other UAVs farther away).

FIG. 5A illustrates a workflow of radio channel identification and reaction. As shown in FIG. 5A, a system 500, implemented in processing circuitry of, for example, control center 116 (FIG. 1) receives RF signals from SDR receivers (e.g., SDR receivers 118 (FIG. 1)) at block 502. Demodulated raw data 504 from the SDR receiver can be processed by the processing circuitry (either at the control center 116 or remotely) to implement telemetry protocol identification 506 based on protocol classifiers 514. Warning information 508 (e.g., video warning frames) can be generated and transmitted in response to RF recognition and decoding 510. Simulated commands 512 can be generated and transmitted, in response to the protocol identification 506, wherein protocol identification 506 occurs based on protocol classifiers 514. Warning information 508 and simulated commands 512 can be transmitted by transmission processor 516 and RF transmitters 518 on the video streaming channel (e.g., channel 208 (FIG. 2)).

FIG. 5B illustrates further details on modulation identification and data recovery as can be performed by processing circuitry or other components of a control center 116 (FIG. 1) to determine whether radio characteristics and protocols of received transmissions. As illustrated in FIG. 5B, processing circuitry can perform a spectral waterfall graph analysis 520 on discrete intermediate frequency (IF) quadrature data, such as using digital image analysis techniques to derive estimates of bandwidth 522 and operational frequencies 524 (e.g., center frequencies) along with estimates of active timeslots 526 corresponding to suspected UAV operation. Identified active timeslots can trigger demodulation 528 of IF quadrature signals into complex-valued baseband signals 530. A modulation pattern identification technique 532 (e.g., density-based spatial clustering of applications with noise (DBSCAN) or other technique) can be used to identify the modulation technique (e.g., constellation 534) to get baseband symbols 536 and convert them into data packets. IQ demodulation 538 can be performed to identify the symbols in the modulated data sequence to provide raw demodulated data packets 540. Regarding the video signal, amateur UAVs generally use phase alternate line (PAL) or national television standards committee (NTSC) video signals and frequency modulation (FM). Accordingly, when a wireless signal is intercepted having FM modulation in the 2.4 GHz or 5.8 GHz ranges, injection 508 of warnings in the video channel can be promptly triggered.

FIG. 5C illustrates workflow 550 of protocol identification. Operations of workflow 550 can be performed by processing circuitry of, for example, the control server 116 (FIG. 1). For the illustrative example of FIG. 5C, for each protocol, a data packet generator 552, 554 can be used to provide training samples. In the generated packets, specific data fields can be filled with range-bound random values. For example, values of coordinates in data packets can be limited to corresponding geographical restrictions defining a surveillance zone. Generated data packets along with random packets 556 can be mixed to form a training set 558 as mentioned elsewhere herein. The training data packets can be converted into labeled vectors with, for example, 200 dimensions. To do this, for m packets with n bytes per packet, Pᵢ={B₁, B₂, . . . , Bₙ}, Paᵢ ∈ {Pa₁, Pa₂, . . . Paₘ}, an appearance probability of different bytes, P(Bᵢ|Training set), can be determined, such as to provide a table having 256 entries. The table can be sorted in ascending order of P(Bᵢ|Training set), and a ranking number can be regarded as its representative code. If a packet length, n, is less than 200, zeros can be inserted to pad the packet. The vectorized packets can be labeled, for example, {Pai, Ii|Ii ∈ {UAVTalk, MultiWii, Random}, and used to derive SVM classifiers 560, to specify whether a packet is from a UAV.

A principal components analysis (PCA) technique can be used to compress a dimensionality of the data. Knowing the UAV's telemetry protocol, processing circuitry (e.g., of control center 116 (FIG. 1) can use protocol decoders 562 to extract UAV payload. If GPS coordinates 564 in the data packet 566 are consistent with the geographical range of the surveillance district, the decoding can be deemed successful 568. The most computationally intensive portions of this illustrative example of a UAV detection scheme can be considered to be implementation of DBSCAN (modulation identification), support vector machine (SVM) (classification), and PCA (dimensionality reduction). For data having a length, n, a time complexity can be represented as O(n log(n)), O(n^{1.2}˜n^{3.4}), and O(n³) respectively.

FIG. 6 illustrates a block diagram of an example comprising a machine 600 upon which any one or more of the techniques (e.g., methodologies) discussed herein may be performed. In various examples, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet device, a set-top box (STB), a personal digital assistant (PDA), a mobile telephone, a web appliance, a network router, switch or bridge, an embedded system such as located in an underwater or surface vehicle, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware comprising the circuitry may include variably connected physical components (e.g., execution units, transistors, simple circuits, etc.) including a computer readable medium physically modified (e.g., magnetically, electrically, such as via a change in physical state or transformation of another physical characteristic, etc.) to encode instructions of the specific operation. In connecting the physical components, the underlying electrical properties of a hardware constituent may be changed, for example, from an insulating characteristic to a conductive characteristic or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit Error! Reference source not found.10, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NEC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Accordingly, machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

### Various Notes

Each of the non-limiting aspects above can stand on its own, or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMS), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A vehicle detection and negation system, comprising:
a communication interface to receive a radio frequency (RF) signal; and
processing circuitry configured to
decode the RF signal;
identify, using a telemetry protocol classifier, a protocol under which the RF signal was transmitted; and
responsive to determining that the protocol corresponds to an unmanned aerial vehicle (UAV) protocol, determine that the RF signal corresponds to a UAV, and encode a negation command for transmission.

2. The vehicle detection and negation system of claim 1, wherein the processing circuitry is further configured to train the telemetry protocol classifier using a dataset comprised of packets generated by a plurality of protocol packet generators.

3. The vehicle detection and negation system of claim 2, wherein the plurality of protocol packet generators generate packets corresponding to at least one of a Micro Air Vehicle Link (MAVLink) protocol, a UAVtalk protocol, and a MultiWii protocol.

4. The vehicle detection and negation system of claim 2, wherein the dataset further includes packets representative of noise of a software-defined radio (SDR).

5. The vehicle detection and negation system of claim 1, further including an interface, coupled to synchronization circuitry, to receive position information of the UAV.

6. The vehicle detection and negation system of claim 5, wherein the processing circuitry is further configured to refrain from encoding the negation command for transmission if the position information indicates that the UAV is not within a range of a sensitive area.

7. The vehicle detection and negation system of claim 1, wherein the processing circuitry is further configured to estimate a signal power of the RF signal.

8. The vehicle detection and negation system of claim 7, wherein the negation command includes a video warning command transmitted to a ground control station the UAV.

9. The vehicle detection and negation system of claim 8, wherein transmission power of the video warning command is determined based on the signal power of the RF signal.

10. The vehicle detection and negation system of claim 7, wherein the negation command includes a jamming signal transmitted to the UAV at a transmission power determined based on the signal power of the RF signal.

11. The vehicle detection and negation system of claim 7, wherein the negation command includes a simulated control signal.

12. A method for vehicle detection and negation, the method comprising:
decoding a radio frequency (RF) signal;
identifying, using a telemetry protocol classifier, a protocol under which the R signal was transmitted; and
responsive to determining that the protocol corresponds to an unmanned aerial vehicle (UAV) protocol,
determining that the RF signal corresponds to a UAV; and
encoding a negation command for transmission.

13. The method of claim 12, further comprising training the telemetry protocol classifier using a dataset comprised of packets generated by a plurality of protocol packet generators, and wherein the plurality of protocol packet generators generate packets corresponding to at least one of a Micro Air Vehicle Link (MAVLink) protocol, a UAVtalk protocol, and a MultiWii protocol.

14. The method of claim 12, further comprising:
determining position information of the UAV; and
refraining from encoding the negation command if the position information indicates that the UAV is riot within a range of a sensitive area.

15. The method of claim 12, further comprising:
estimating a signal power of the RF signal.

16. The method of claim 15, further comprising: determining transmission signal power for transmission of the negation command based on the signal power of the RF signal.

17. A machine-readable medium including instructions that, when executed on processing circuitry, cause the processing circuitry to perform operations including:
decoding a radio frequency (RF) signal;
identifying, using a telemetry protocol classifier, a protocol under which the RF signal was transmitted; and
responsive to determining that the protocol corresponds to an unmanned aerial vehicle (UAV) protocol,
determining that the RF signal corresponds to a UAV; and
encoding a negation command for transmission.

18. The machine-readable medium of claim 17, wherein the operations further include:
training the telemetry protocol classifier using a dataset comprised of packets generated by a plurality of protocol packet generators, and wherein the plurality of protocol packet generators generate packets corresponding to at least one of a Micro Air Vehicle Link (MAV Link) protocol, a UAVtalk protocol, and a MultiWii protocol.

19. The machine-readable medium of claim 17, wherein the operations further include:
determining position information of the UAV; and
refraining from encoding the negation command if the position information indicates that the UAV is not within a range of a sensitive area.

20. The machine-readable medium of claim 17, wherein the operations further include:
estimating a signal power of the RF signal; and
determining transmission signal power for transmission of the negation command based on the signal power of the RF signal.
